(19) United States
(12) Patent Application Publication
(10) Pub. No.: US 2007/0035128 A1
(43) Pub. Date: Feb. 15, 2007

(54) Fluid coupling with anti-rotation feature

(76) Inventors: Martin M. Mann, Jackson, MI (US); William C. Marrison, Jackson, MI (US); Gary M. Jenski JR., Jackson, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/200,896

(22) Filed: Aug. 10, 2005

(51) Int. Cl. F16L 37/00

(52) U.S. Cl. 285/308

(57) ABSTRACT

A fluid coupling is provided that includes a first coupling member including a body portion having a radially outwardly extending polygonal-shaped protrusion. A second coupling member includes a first stage adapted to connect the first coupling member to the second coupling member, a second stage adapted to open the second coupling member for fluid flow therethrough, and an inwardly facing polygonal-shaped cavity sized to receive the polygonal-shaped protrusion on the first coupling member when the first and second members are connected to inhibit relative rotation between the first and second coupling members.

### BACKGROUND OF THE INVENTION

1. Field of the Invention

The present invention relates to a fluid coupling and to a two-stage fluid coupling that includes an anti-rotation feature.

2. Description of the Related Art

There are many applications where a fluid conveying system requires that a connection be made between two components, such as a between a hose and a pump, motor or valve. Recently, push-to-connect style fluid couplings have become available that operate to make this connection with little or no fluid loss. In one such fluid coupling, the two mating coupling members are joined in two stages—a first stage in which the mating coupling members are physically connected and a second stage in which fluid flow through the coupling is enabled. Commonly known as “two-stage” couplings, these devices enable the coupling members to be connected and then gradually opened to permit fluid flow therethrough.

### SUMMARY OF THE INVENTION

A fluid coupling is provided that includes a first coupling member having a body portion with a radially outwardly extending polygonal-shaped protrusion. A second coupling member includes a first stage adapted to connect the first coupling member to the second coupling member, a second stage adapted to open the second coupling member for fluid flow therethrough, and an inwardly facing polygonal-shaped cavity sized to receive the polygonal-shaped protrusion on the first coupling member when the first and second members are connected to inhibit relative rotation between the first and second coupling members. Other aspects of the invention will be apparent to those skilled in the art after review of the drawings and detailed description provided below.

### BRIEF DESCRIPTION OF THE DRAWINGS

Embodiments of the invention will now be described, by way of example, with reference to the accompanying drawings, wherein:

FIG. 1 is an exploded, partial cross-sectional view of a fluid coupling according to an embodiment of the present invention;

FIG. 2 is a partial cross-sectional view of the fluid coupling of FIG. 1 shown during insertion of a first coupling member into a second coupling member;

FIG. 3 is a partial cross-sectional view of the fluid coupling of FIG. 1 showing the first and second coupling members connected;

FIG. 4 is a partial cross-sectional view of a fluid coupling of FIG. 1 showing the first and second coupling members connected and opened to fluid flow;

FIG. 5 is an end view of a second coupling member according to an embodiment of the present invention; and

FIG. 6 is partial cross-sectional view of a second coupling member according to another embodiment of the present invention.

### DETAILED DESCRIPTION

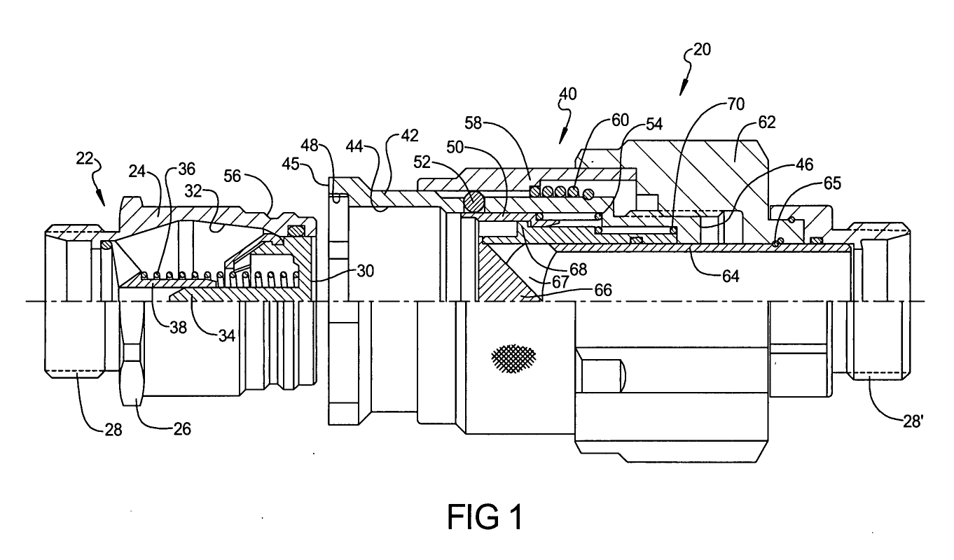

Referring to FIG. 1, a fluid coupling 20 according to an embodiment of the present invention is shown. In an embodiment, fluid coupling 20 includes a first or male coupling member 22 having a body portion 24 with a radially outwardly extending polygonal-shaped protrusion 26. In a particular configuration, polygonal-shaped protrusion 26 is hexagonal in shape to enable the protrusion to be engaged by a wrench or other tool for securing an adapter portion 28 of first coupling member 22 to another fluid conveying component (not shown).

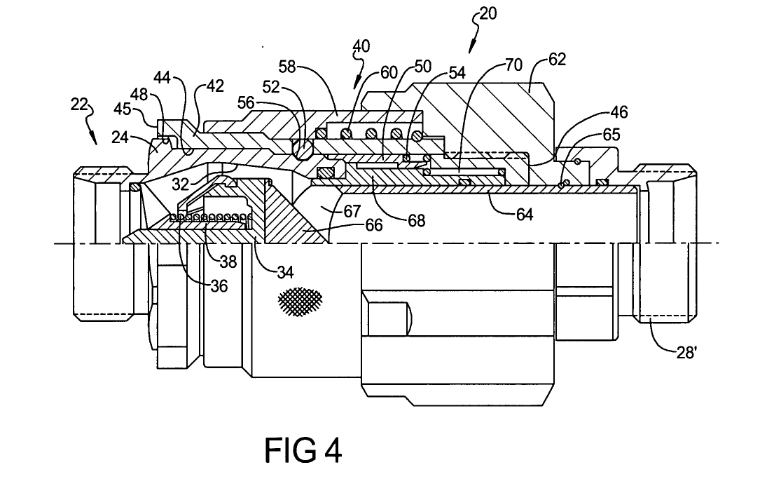

First coupling member 22 also includes a first opening 30 communicating with a first axial passageway 32. An optional axially extending valve member 34 is movable within axial passageway 32 between a closed position (see, e.g., FIG. 1), in which valve member 34 is sealingly positioned within first opening 30 to inhibit fluid flow through first coupling member 22, and an open position (see, e.g., FIG. 4), in which fluid is free to flow through first coupling member 22. In the illustrated embodiment, valve member 34 is yieldingly urged toward the closed position by a spring 36 and is axially guided between the closed and open positions by a valve guide 38. The spring and valve guide configuration for urging and guiding valve member 34 between the closed and open positions is provided by way of example only, and is not intended to be limited to that shown in the drawings and described above.

In an embodiment, fluid coupling 20 also includes a second or female coupling member 40 having a first stage adapted to connect first coupling member 22 to second coupling member 40 while second coupling member 40 is closed, and a second stage adapted to open second coupling member 40 for fluid flow therethrough. Second coupling member 40 also includes a body 42 having a second axial passageway 44 extending along an axis from a receiving end 45 to a trailing end 46. Receiving end 45 is sized to receive first coupling member body portion 24 and defines a second opening to the mouth of second axial passageway 44.

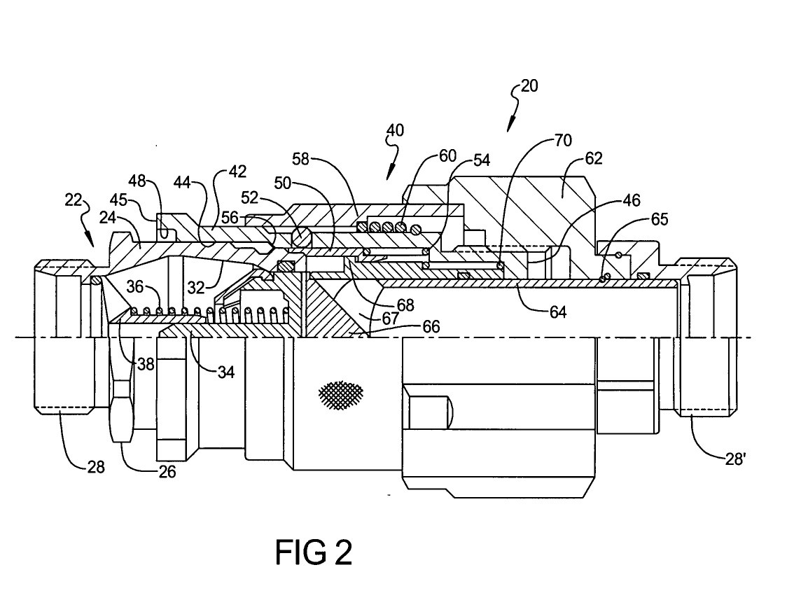

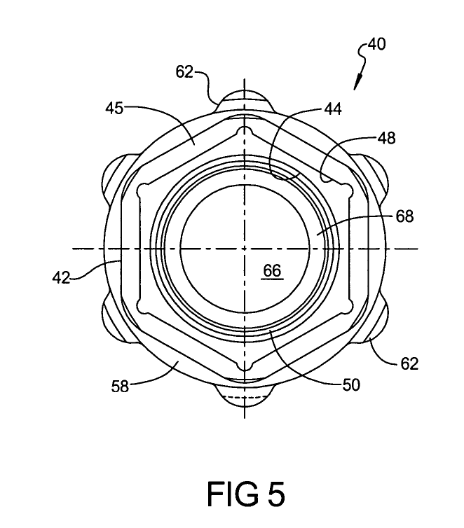

In the embodiment shown in FIGS. 1-5, second coupling member 40 also includes an inwardly facing polygonal-shaped cavity 48 sized to receive polygonal-shaped protrusion 26 on first coupling member 22 when first and second coupling members 22, 40 are connected to inhibit relative rotation between first and second coupling members 22, 40. In an embodiment, polygonal-shaped cavity 48 is positioned within body 42 of second coupling member 40. In the illustrated configuration, polygonal-shaped cavity 48 is generally hexagonal in shape to receive the corresponding hexagonal-shaped protrusion 26 on first coupling member 22.

In addition to their cooperative anti-rotation capability, polygonal-shaped protrusion 26 and polygonal-shaped cavity 48 may be keyed to permit the connection of only certain coupling members. For example, if fluid coupling 20 is designated to transmit a first type of fluid, e.g., fuel, the fluid coupling may be provided with a hexagonal-shaped protrusion/cavity combination. In contrast, if fluid coupling 20 is designated to transmit a second type of fluid, e.g., hydraulic fluid, the fluid coupling may be provided with an octagonal-shaped protrusion/cavity combination. In this manner, a first member with a hexagonal-shaped protrusion would not be able to connect with a second member having an octagonal-shaped cavity.

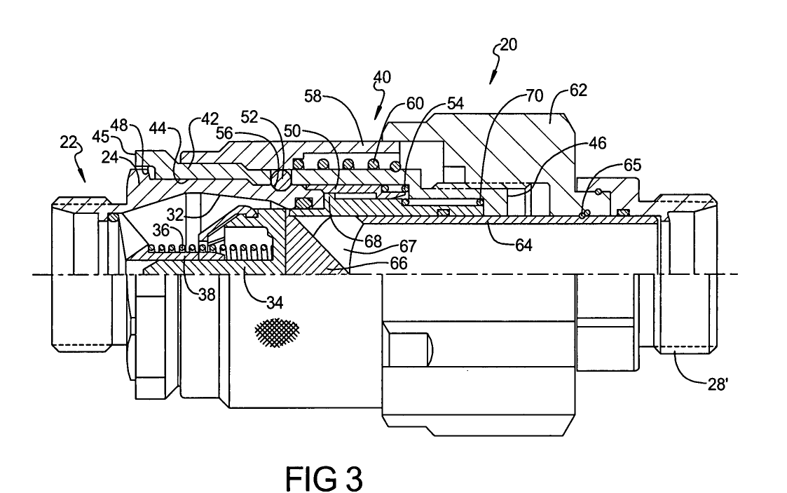

In an embodiment, the first stage of second coupling member 40 includes a generally cylindrical retainer sleeve 50 positioned to be engaged and moved by first coupling member 22 from a first position (see, e.g., FIG. 1), in which at least one locking member 52 is stowed, to a second position (see, e.g., FIG. 3), in which locking member 52 is deployed to connect first coupling member 22 to second coupling member 40. Retainer sleeve 50 may include a spring 54 or other resiliently compressible member yieldingly urging the retainer sleeve toward the first position. In a particular configuration, locking member 52, which may include an arc-shaped latch or a ball, is adapted for receipt in a groove 56 in body portion 24 when first coupling member 22 is connected to second coupling member 40. When deployed, locking member 52 is prevented from moving to the stowed position by an axially slidable and generally cylindrical release sleeve 58, which includes a spring or other resiliently compressible member 60 yieldingly urging release sleeve 58 and locking member 52 toward the deployed position shown in FIG. 3.

In an embodiment, the second stage of second fluid coupling 40 includes a nut 62 rotatably connected to body 42, such as by a threaded connection, for axial movement thereon. A second valve member 64 may be connected to nut 62 for axial movement therewith using a retaining member 65, such as a locking ring(s), which enables nut 62 to rotate relative to second valve member 64. Nut 62 may also include an adapter portion 28′, which may be rotatably connected to nut 62 for relative rotation therebetween. The interface between adapter portion 28′ and either nut 62 or second valve member 64 may include a seal to inhibit fluid leakage.

In the illustrated configuration, second valve member 64 includes a head 66 engageable with first valve member 34. Head 66 is adapted to urge first valve member 34 toward the open position when nut 62 is rotated in a first direction and to permit first valve member 34 to be moved toward the closed position when nut 62 is rotated in a second direction. Second valve member 64 includes at least one port 67 that allows passage of fluid through the second valve member when second coupling member 64 is opened to fluid flow.

The second stage of second valve member 40 may also include a valve sleeve 68 having a spring or other resiliently compressible member 70 yieldingly urging the valve sleeve into sealing engagement with second valve member 64. When so configured, first coupling member body portion 24 is adapted to inhibit movement of valve sleeve 68 when first coupling member 22 is connected to second coupling member 40, which permits second valve member 64 to separate from valve sleeve 68 and fluid to flow through second coupling member 40 (see, e.g., FIG. 4).

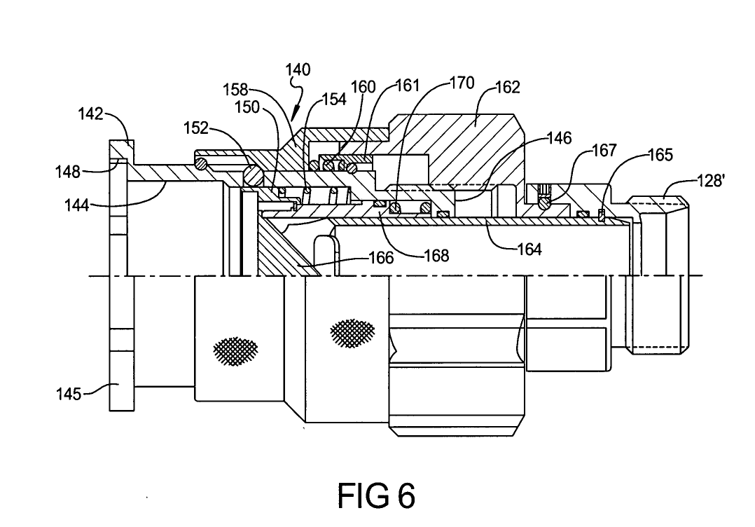

Referring to FIG. 6, a second coupling member 140 according to another embodiment of the present invention is shown. In the illustrated embodiment, second coupling member 140 includes a first stage adapted to connect first coupling member 22 to second coupling member 140 while second coupling member 140 is closed, and a second stage adapted to open second coupling member 140 for fluid flow therethrough. Second coupling member 140 also includes a body 142 having a second axial passageway 144 extending along an axis from a receiving end 145 to a trailing end 146. Receiving end 145 is sized to receive first coupling member body portion 24 and defines a second opening to second axial passageway 144.

Second coupling member 140 also includes an inwardly facing polygonal-shaped cavity 148 sized to receive polygonal-shaped protrusion 26 on first coupling member 22 when first and second coupling members 22, 140 are connected to inhibit relative rotation between first and second coupling members 22, 140. In an embodiment, polygonal-shaped cavity 148 is positioned within body 142 of second coupling member 140. In the illustrated configuration, polygonal-shaped cavity 148 is generally hexagonal in shape to receive the corresponding hexagonal-shaped protrusion 26 on first coupling member 22, but is not necessarily limited thereto.

In the embodiment illustrated in FIG. 6, the first stage of second coupling member 140 includes a generally cylindrical retainer sleeve 150 positioned to be engaged and moved by first coupling member 22 from a first position (see, e.g., FIG. 6), in which at least one locking member 52 is stowed, to a second position, in which locking member 152 is deployed to connect first coupling member 22 to second coupling member 140. Retainer sleeve 150 includes a spring 154 or other resiliently compressible member yieldingly urging the retainer sleeve toward the first position. When deployed, locking member 152 is prevented from moving to the stowed position by an axially slidable and generally cylindrical release sleeve 158, which includes a spring or other resiliently compressible member 160 yieldingly urging release sleeve 158 and locking member 152 toward the deployed position. Spring 160 is supported on body 142 by a retainer 161 that may be secured to body 142 with a locking ring or the like.

In an embodiment, the second stage of second fluid coupling 140 includes a nut 162 rotatably connected, such as by a threaded connection, to body 142 for axial movement thereon. A second valve member 164 may be connected to nut 162 for axial movement therewith using a retaining member 165, such as a locking ring, which enables nut 162 to rotate relative to second valve member 164. Nut 162 may include an adapter 128′, such as a threaded adapter, which is rotatably connected to nut 162. The interface between the adapter 128′ and either nut 162 or second valve member 164 may include a seal to inhibit fluid leakage therebetween. Adapter 128′ may be rotatably connected to nut 162 using a set-screw retained ball 167 or other locking mechanism, such as a locking ring and the like.

In the illustrated configuration, second valve member 164 includes a head 166 engageable with first valve member 34 and adapted to urge first valve member 34 toward the open position when nut 162 is rotated in a first direction and to permit first valve member 34 to be moved toward the closed position when nut 162 is rotated in a second direction. The second stage of second valve member 140 may also include a valve sleeve 168 having a spring or other resiliently compressible member 170 yieldingly urging the valve sleeve into sealing engagement with second valve member 164. When so configured, first coupling member body portion 24 is adapted to inhibit movement of valve sleeve 168 when first coupling member 22 is connected to second coupling member 140, which permits second valve member 164 to separate from valve sleeve 168 and fluid to flow through second coupling member 140.

Connection and operation of fluid coupling 20 will now be described with reference to FIGS. 1-5. In an embodiment, first coupling member 22 is first inserted into second coupling member 40 causing body portion 24 to engage and move retainer sleeve 50 to expose locking members 52. During insertion, polygonal-shaped protrusion 26 is aligned with polygonal-shaped cavity 48. Upon sufficient movement of first coupling member 22 into second coupling member 40, locking members 52 are deployed into groove 56 on body portion 24 and release sleeve 58 is moved by spring 60 to a position that prevents locking members from being pushed from their deployed position. At this point, first and second coupling members 22, 40 are connected, first valve member 34 is in the closed position and polygonal-shaped protrusion 26 is received in polygonal-shaped cavity 48 to inhibit relative rotation between first and second coupling members 22, 40.

To permit fluid flow through fluid coupling 20, nut 62 is rotated in the first direction, e.g., clockwise, causing second valve member 64 to be moved axially within second axial passageway 44. Axial movement of second valve member 64 forces the engaged first valve member 34 to be moved toward the open position (see, e.g., FIG. 4). Rotation of body 42 with nut 62 is inhibited by virtue of polygonal-shaped protrusion 26 engaging the inner surface of polygonal-shaped cavity 48. Nut 62 may be rotated until it engages release sleeve 58, at which point first valve member 34 is in the open position and full fluid flow is permitted through fluid coupling 20. To terminate fluid flow through fluid coupling 20, such as when fluid coupling 20 is to be disconnected, nut 62 may be rotated in the second direction, e.g., counter-clockwise, to move first valve member 34 back to the closed position and second valve member 64 into sealing engagement with valve sleeve 68. When nut 62 is sufficiently rotated, release sleeve 58 may be retracted on body 42 to allow locking members to move out of groove 56 and first coupling member 22 to be removed from second coupling member 40.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A fluid coupling, comprising:
a first coupling member including a body portion having a radially outwardly extending polygonal-shaped protrusion; and
a second coupling member including a first stage adapted to connect the first coupling member to the second coupling member, a second stage adapted to open the second coupling member for fluid flow therethrough, and an inwardly facing polygonal-shaped cavity sized to receive the polygonal-shaped protrusion on the first coupling member when the first and second members are connected to inhibit relative rotation between the first and second coupling members.

2. The fluid coupling of claim 1, wherein the first coupling member includes a first opening communicating with a first axial passageway and an axially extending valve member movable within the axial passageway between a closed position and an open position, the first valve member including a leading portion that extends through the first opening when the valve member is in the closed position.

3. The fluid coupling of claim 1, wherein the polygonal-shaped protrusion and the polygonal-shaped cavity are hexagonal in shape.

4. The fluid coupling of claim 1, wherein the first stage includes a retainer sleeve positioned to be engaged and moved by the first coupling member from a first position in which at least one locking member is stowed to a second position in which the locking member is deployed to connect the first coupling member to the second coupling member, the retainer sleeve including a spring yieldingly urging the retainer sleeve toward the first position.

5. The fluid coupling of claim 1, wherein the second coupling member includes a body having a second axial passageway extending along an axis from a receiving end to a trailing end, the receiving end sized to receive the first coupling member body portion and defining a second opening to the second axial passageway.

6. The fluid coupling of claim 5, wherein the polygonal-shaped cavity is positioned within the second opening.

7. The fluid coupling of claim 5, further including a nut rotatably connected to the body for axial movement thereon.

8. The fluid coupling of claim 7, wherein the second stage includes a second valve member connected to the nut.

9. The fluid coupling of claim 8, wherein the first coupling member includes a first valve member moveable within the first coupling member between an open and a closed position, the second valve member including a head engageable with the first valve member to urge the first valve member toward the open position when the nut is rotated in a first direction and to permit the first valve member to be moved toward the closed position when the nut is rotated in a second direction.

10. The fluid coupling of claim 8, wherein the second stage includes a valve sleeve having a spring yieldingly urging the valve sleeve into sealing engagement with the second valve member, wherein the first coupling member body portion is adapted to inhibit movement of the valve sleeve when the first coupling member is connected to the second coupling member.

11. A fluid coupling, comprising:
a first coupling member including a body portion having a radially outwardly extending polygonal-shaped protrusion, a first opening communicating with a first axial passageway, and an axially extending valve member movable within the axial passageway between a closed position and an open position, the first valve member including a leading portion that extends through the first opening when the valve member is in the closed position;
a second coupling member including:
a body having a second axial passageway extending along an axis from a receiving end to a trailing end, the receiving end sized to receive the first coupling member body portion and defining a second opening to the second axial passageway;
an inwardly facing polygonal-shaped cavity sized to receive the polygonal-shaped protrusion on the first coupling member when the first and second members are connected to inhibit relative rotation between the first and second coupling members;
a retainer sleeve positioned to be engaged and moved by the first coupling member from a first position in which at least one locking member is stowed toward a second position in which the locking member is deployed to connect the first coupling member to the second coupling member, the retainer sleeve including a spring yieldingly urging the retainer sleeve toward the first position;
a nut rotatably connected to the body for axial movement thereon;
a second valve member connected to the nut and including a head engageable with the first valve member to urge the first valve member toward the open position when the nut is rotated in a first direction and to permit the first valve member to be moved toward the closed position when the nut is rotated in a second direction; and
a valve sleeve having a spring yieldingly urging the valve sleeve into sealing engagement with the second valve member; wherein the first coupling member body portion is adapted to inhibit movement of the valve sleeve when the first coupling member is connected to the second coupling member.

12. A female coupling member for use with a male coupling member having a radially outwardly extending polygonal-shaped protrusion, the female coupling member comprising:
a first stage adapted to connect the male coupling member to the female coupling member, a second stage adapted to open the female coupling member for fluid flow therethrough, and an inwardly facing polygonal-shaped cavity sized to receive the polygonal-shaped protrusion on the male coupling member when the male and female coupling members are connected to inhibit relative rotation of the male and female coupling members.

13. The female coupling member of claim 12, wherein the female coupling member is further adapted for use with a male coupling member that includes a first opening communicating with a first axial passageway and an axially extending valve member movable within the axial passageway between a closed position and an open position, the first valve member including a leading portion that extends through the first opening when the valve member is in the closed position.

14. The female coupling member of claim 12, wherein the polygonal-shaped protrusion and the polygonal-shaped cavity are hexagonal in shape.

15. The female coupling member of claim 12, wherein the first stage includes a retainer sleeve positioned to be engaged and moved by the first coupling member from a first position in which at least one locking member is stowed to a second position in which the locking member is deployed to connect the male coupling member to the female coupling member, the retainer sleeve including a spring yieldingly urging the retainer sleeve toward the first position.

16. The female coupling member of claim 12, wherein the female coupling member includes a body having a second axial passageway extending along an axis from a receiving end to a trailing end, the receiving end sized to receive the male coupling member body portion and defining a second opening to the second axial passageway.

17. The female coupling member of claim 16, wherein the polygonal-shaped cavity is positioned within the second opening.

18. The female coupling member of claim 16, further including a nut rotatably connected to the body for axial movement thereon.

19. The female coupling member of claim 18, wherein the second stage includes a second valve member connected to the nut.

20. The female coupling member of claim 19, wherein the male coupling member includes a first valve member moveable within the male coupling member between an open and a closed position, the second valve member including a head engageable with the first valve member to urge the first valve member toward the open position when the nut is rotated in a first direction and to permit the first valve member to be moved toward the closed position when the nut is rotated in a second direction.

21. The female coupling member of claim 19, wherein the second stage includes a valve sleeve having a spring yieldingly urging the valve sleeve into sealing engagement with the second valve member, wherein the male coupling member body portion is adapted to inhibit movement of the valve sleeve when the male coupling member is connected to the female coupling member.

22. A female fluid coupling member for use with a male coupling member having a radially outwardly extending polygonal-shaped protrusion, a first opening communicating with a first axial passageway, and an axially extending valve member movable within the axial passageway between a closed position that closes the opening and an open position, the female coupling member comprising:
a body having a second axial passageway extending along an axis from a receiving end to a trailing end, the receiving end sized to receive the male coupling member body portion and defining a second opening to the second axial passageway;
an inwardly facing polygonal-shaped cavity sized to receive the polygonal-shaped protrusion on the male coupling member when the male and female coupling members are connected to inhibit relative rotation between the male and female coupling members;
a retainer sleeve positioned to be engaged and moved by the male coupling member from a first position in which at least one locking member is stowed toward a second position in which the locking member is deployed to connect the male coupling member to the female coupling member, the retainer sleeve including a spring yieldingly urging the retainer sleeve toward the first position;
a nut rotatably connected to the body for axial movement thereon;
a second valve member connected to the nut and including a head engageable with the first valve member to urge the first valve member toward the open position when the nut is rotated in a first direction and to permit the first valve member to be moved toward the closed position when the nut is rotated in a second direction; and
a valve sleeve having a spring yieldingly urging the valve sleeve into sealing engagement with the second valve member; wherein the male coupling member body portion is adapted to inhibit movement of the valve sleeve when the male coupling member is connected to the female coupling member.
